(19) United States
(12) Patent Application Publication
(10) Pub. No.: US 2016/0104122 A1
(43) Pub. Date: Apr. 14, 2016

(54) REMOTE VIDEO CONFERENCING SYSTEM

(71) Applicant: BANK OF AMERICA CORPORATION, CHARLOTTE, NC (US)

(72) Inventors: Christian Michael Mande, Charlotte, NC (US); Tyler Johnson, Tega Cay, SC (US); Nathan Dent, Concord, NC (US); James Robert Grimsley, Dover, FL (US); Sara Gill, New York, NY (US); Kristy M. Crist, Charlotte, NC (US)

(21) Appl. No.: 14/512,136

(22) Filed: Oct. 10, 2014

(51) Int. Cl. G06Q 10/10; H04N 7/15; H04W 4/02

(52) U.S. Cl. CPC G06Q 10/1095; H04W 4/02; H04N 7/15

(57) ABSTRACT

Embodiments of the invention are directed to a system, method, and computer program product to check-in for a specialist session. The system typically including a memory, a processor and a module configured to receive an indication that a customer has an appointment scheduled to participate in a specialist session at a business location; determine that a mobile device in possession of the customer is located within a geographic area defined by the business location and encompasses the business location; and in response to determining that the mobile device is located within the geographic area defined by the business location, place the customer in a queue associated with the specialist session.

### FIELD

In general, embodiments of the invention relate to configuring a video conference system to enable a customer to check-in with an entity prior to the initiation of the specialist session to reduce wait time.

### BACKGROUND

Banks and other financial institutions seek to continually improve the customer banking experience through the use of technology. Recent innovation in mobile technology has advanced the efforts of banks and other financial institutions in improving customer service and accessibility to offered services and overall convenience.

However, many of these recent innovations have an increasing wait time and pre-processing time as the number of customers using the service is increasing. As such, a need exists for an invention that overcomes the deficiencies of the current systems and methods.

### BRIEF SUMMARY

Embodiments of the present invention address the above needs and/or achieve other advantages by providing apparatuses (e.g., a system, computer program product, and/or other device) and methods for pre-stage registration and check-in for use of a video conference system. The present invention reduces wait time of the customer by enabling the customer to begin one or more pre-processing steps (e.g., check-in, complete documents, provide authentication, provide information, or the like) associated with the video conferencing system prior to entering the business location. When the user is within the business location (or otherwise near the business location), the user may transfer the completed pre-processing steps to the video conference system (or a specialist associated with the video conference system, employee/greeter at the business location, or the like) and have a seamless transition of service.

Embodiments of the invention include systems, computer program products, and methods to enable a customer to check-in for a specialist session. The invention receives an indication that a customer has an appointment scheduled to participate in a specialist session at a business location; determines that a mobile device in possession of the customer is located within an area defined by the business location and is associated with the business location; and places the customer in a queue associated with the specialist session in response to determining that the mobile device is located within the area defined by the business location.

In further accord with an embodiment, the invention receives information from the customer, wherein the mobile device in possession of the customer is located within the area defined by the business location but not located at the business location, wherein the information received from the customer is associated with the specialist session; determines that the customer has entered the business location; and transfers the information received from the customer to the video conference system for the specialist session.

In another embodiment, the invention schedules the appointment for the customer to participate in the specialist session at the business location, wherein scheduling further comprises receiving a request from the customer to schedule the specialist session, wherein the request comprises a specialist type, a geographic location preference, a preferred time, and/or one or more pre-filled forms required to participate the specialist session.

In still another embodiment, the invention initiates a presentation of a user interface on the mobile device, wherein the user interface enables the customer to provide a confirmation that the customer is located within the area defined by the business location.

In yet another embodiment, the invention authenticates the customer prior to placing the customer in the queue. Authenticating the customer comprises receiving one or more authentication credentials associated with the customer; comparing the one or more received authentication credentials to the one or more authentication credentials associated with the customer stored in a database to determine a match; and authenticating the customer to be placed in the queue in response to determining the match.

In further accord with another embodiment, the invention provides a notification to the customer based on at least a successful authentication, wherein the notification comprises at least one of a direction to the video conference system at the business location, a wait time associated with the specialist session, and/or information associated with a specialist participating in the specialist session.

In another embodiment, the invention determines that the customer is currently within the area defined by the business location, but not at the business location; transmits a reminder to the customer, wherein the reminder is associated with the specialist session scheduled by the customer, wherein the reminder is transmitted to the customer a predetermined amount of time prior to the lapse of a wait time associated with the specialist session; and receives a response from the customer acknowledging the reminder within a predetermined amount of time in response to transmitting the reminder, wherein the response is an indication that the customer will reach the business location to participate in the specialist session prior to the lapse of the wait time.

In still another embodiment, the invention determines that the customer has not acknowledged the reminder within the predetermined amount of time; determines an alternate wait time associated with the specialist session, wherein the alternate wait time is determined based on at least placing the customer in the next available position in the queue associated with the specialist session; and transmits a notification to the customer, wherein the notification comprises at least the alternate wait time associated with the specialist session to the customer.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 presents a process flow to enable a customer to check-in for a video conference system according to one aspect of the present invention;

FIG. 2 presents a process flow to enable a customer to pre-register for a video conference system according to one aspect of the present invention;

FIG. 3 presents a process flow to confirm the scheduled specialist session with the customer according to one aspect of the present invention;

FIG. 4 presents a process flow for determining an alternate wait time associated with the specialist session according to one aspect of the present invention;

FIG. 5 illustrates an exemplary block diagram of the system environment;

FIG. 6 presents a process flow to provide customer interaction-focused enhancements for video conference systems according to one aspect of the present invention;

FIG. 7 presents a video conference system display according to one aspect of the present invention;

FIG. 8 presents devices integrated within the video conference system according to one aspect of the present invention;

FIG. 9 presents data transmission methods according to one aspect of the present invention; and

FIG. 10 presents a system environment for providing customer interaction-focused enhancements for video conference systems according to one aspect of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In other embodiments of the invention, an “entity” may be another business related to a financial institution or another type of business.

In some embodiments, the entity may allow a customer to establish an account with the entity. An “account” may be the relationship that the customer has with the entity. Examples of accounts include a deposit account, such as a transactional account (e.g. a banking account), a savings account, an investment account, a money market account, a time deposit, a demand deposit, a pre-paid account, a credit account, a non-monetary customer profile that includes only personal information associated with the customer, or the like. The account is associated with and/or maintained by an entity.

In some embodiments, a “customer” may be a financial institution customer (e.g., an account holder or a person who has an account (e.g., banking account, credit account, or the like), or a potential customer (e.g., a person who has submitted an application for an account, a person who is the target of marketing materials that are distributed by the entity, a person who applies for a loan that not yet been funded). In some other embodiments, a customer may not be associated with the financial institution. In some embodiments, an “employee” may be a financial institution employee (e.g., an underwriter, a project manager, an IT specialist, a manager, an administrator, an internal operations analyst, bank teller, contractor, or the like). In one aspect of the invention, an employee may be capable of facilitating a transaction between the entity and a customer.

Customers of businesses, such as financial institutions, that have one or more customer service locations (otherwise referred to as centers, branches or the like), expect to receive complete assistance associated with any of the wide range of services offered by the businesses when the customers visit any of the service locations. For example, financial institutions offer a number of services such as mortgage/loans, treasury management, credit services, foreign exchange services, investment management, or the like. Businesses have come to realize that having full time specialists during normal business hours at each service location is inefficient. For example, in the financial institution setting, if each banking center employs at least one full-time mortgage/loan specialist, a full-time small business specialist and/or a full-time personal financial advisor/specialist, the specialist may only be called upon in regards to their specialty in the event a customer visits the banking center requiring assistance in their respective area of specialty.

Many businesses, such as financial institutions, have addressed the problem associated with staffing a customer service location with full-time specialists by implementing video conference (VC) systems. A VC system uses telecommunication and information technologies to provide specialist services by implementing two-way video communication between a customer and a specialist located remotely. VC systems are typically set-up in private settings within the business location (e.g., private rooms, offices, cubicles, or the like) to provide the customer assurance that the information exchanged during a VC session is held in private. In this regard, a business location/center equipped with VC communication can provide customers on-demand access to specialists having different areas of specialty/expertise without requiring the full-time physical presence of the specialist at the business outlet/center.

As illustrated, aspects of the present disclosure include methods, systems, and computer program products to enable a customer to pre-register and/or check-in for use of a VC system. It will be appreciated that, although embodiments of the present invention are generally described in the context of specialist sessions, the system may be configured to be used with any scheduled session with any employee in a business location.

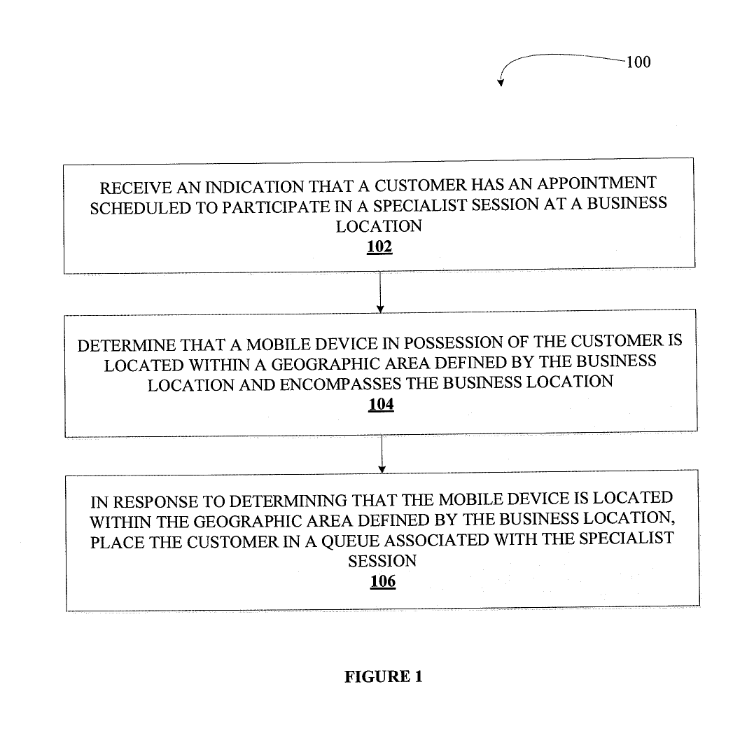

FIG. 1 illustrates a process flow to enable a customer to check-in for a video conference system 100. As shown in block 102, the process flow includes receiving an indication that a customer has an appointment scheduled to participate in a specialist session at a business location. In some embodiments, the indication may be a reminder (also described as a notification) that is set up to notify an employee at the business location. In one aspect, the reminder may be a pop-up notification, a text message, an email, or the like. Typically, the appointment is scheduled by the customer prior to participating in the specialist session. In some embodiments the indication may be manually sent by the customer or automatically by the customer. For example, the indication may be based on the location of the customer, the location of the customer's mobile device, or the like. The indication may be received from the customer's mobile device when the customer's mobile device is tracked as moving towards the business, is located within a specific distance from the business, is within a pre-defined area associated with the business, or the like, as explained in further detail later.

In response to receiving the indication, the process flow includes determining that the mobile device in possession of the customer is located within an area (e.g., geographic area, radius from a specific point, vertical location such as in a building with multiple floors, square or other shaped blocks, shape of the footprint of the building, or the like) defined by the business location and/or encompasses the business location, as shown in block 104. In one aspect, determining the location of the mobile device in possession of the customer may be achieved by tracking the geographic positioning system (GPS) coordinates associated with a location device embedded in the mobile device. In another aspect, determining the location of the mobile device in possession of the customer may be achieved by determining that the mobile device has automatically connected to a wireless communication module associated with the business location. Typically, the mobile device is preconfigured to connect to the wireless communication module at the business location when the customer is within a specific distance from the business location (e.g., within the range of the wireless network). In one aspect, the mobile device in possession of the customer is preconfigured to connect to the wireless communication module associated with the business location when the customer schedules an appointment to participate in the specialist session.

In some embodiments, the area may be a geo-fence associated with the business location. Typically, a geo-fence is a dynamically generated radius around a business location; however, it may be an electronic definition of any area discussed herein. In one aspect, the geo-fence may be a predefined set of boundaries within a section of the business location, or otherwise around the business location, or overlapping a business location. In some embodiments, the system may be configured to determine that the mobile device in possession of the customer is located within or near an area by virtue of the customer entering/exiting a barrier, an entrance, or the like associated with the geo-fence of the business location. For example, the system may determine that the customer is within the area associated with the business location when the customer enters the parking lot, building, block, or the like associated with the business location, thereby entering the geo-fence defined by the business location. In one aspect, an employee (e.g., greeter, teller, associated, or the like) at the business location may be notified of the presence of the mobile device within the area defined by the business location by a pop up message, a text message, an email, alarm, an indicator on a computing device, mobile device, or any other like notification.

In response to determining that the mobile device in possession of the customer is located within the area defined by the business location, the process flow includes placing the customer in a queue associated with the specialist session, as shown in block 106. The queue may include the line of customers waiting to use the video collaboration system, an indication of the estimated arrival time of the customers, the amount of time left for specialist sessions with other customers, or the like. Typically, even though the customer may have a scheduled an appointment with a specialist, the customer may have to wait past the customer's scheduled time for the specialist session. In some embodiments, other customer's using the video terminals associated with the video collaboration systems may extend past scheduled times. In other embodiments, one or more of the video terminals associated with the video collaboration system may be experiencing computer problems, and thus may be out of order. In some situations, the employee at the business location may have to assimilate requisite forms and documents associated with the customer participating in the specialist session, which in turn, may increase the wait time further. By placing the customer in the queue based on determining that the location of the mobile device in possession of the customer is within the area defined by the business location, the overall wait time associated with the customer participating in the specialist session may be reduced. The additional time saved (e.g. time from detection of the customer until the customer arrives) may be used by the employee at the business location to prepare the requisite forms and assimilate the requisite documents.

In some embodiments, the customer may have to provide one or more authentication credentials (e.g., pin number, site key, user name, eye scan, thumb or finger print, other biometric information, gesture, image, facial recognition, or the like) in order to be placed in the queue and/or begin the specialist session before arriving. In one aspect, the one or more authentication credentials provided by the customer (e.g., before or after the customer arrives in the defined business area, the actual business location, or the like) may be compared to the one or more authentication credentials stored in a database of the business to determine a match between the authentication credentials provided and the authentication credentials stored, and thus place the customer in the queue when a match exists. In response to a successful authentication (or in response to a request by the customer, or other event), in some embodiments, a notification may be sent to the customer indicating at least one of a direction to the video conference system at the business location, a wait time associated with the specialist session, information about the topic of the specialist session, documents needed for the specialist session, information needed for the specialist session, information associated with the specialist participating in the specialist session, or other like information.

In some embodiments, the system may be configured to enable the customer to begin a transaction (or other related financial institution action) on the mobile device in possession of the customer, and complete the transaction using the video conference system at the business location. In one aspect, the system may determine that the mobile device in possession of the customer is within the area (e.g., geolocation area) defined by the business location. In response, the system may initiate the presentation of a user interface on the mobile device in possession of the customer to begin one or more preliminary processes associated with the customer's scheduled appointment with the specialist. The preliminary processes may include authenticating the customer, filling out documentation, providing financial information about the customer or the customer's accounts, indicating transactions or actions in which the customer is interested, indicating questions the customer may have regarding transactions or actions, or the like. As such, when the customer enters the business location (e.g., enters an area defined by the business, enters the actual business location, an area within the business location, or the like), the system may be configured to transfer information from the customer's mobile device to the video conference system to continue providing seamless service to the customer.

In another aspect, the system may be configured to determine that an automated machine associated with the business location (e.g., automated teller machine, kiosk, terminal, mobile device, or other like automated machine at the business location or in a location outside of the business location) may not be providing adequate customer service to a customer. For example, the customer may be using an automated machine for an action, and request help regarding the action, be presented with help options based on an occurrence (e.g., failure to make a selection within a timeframe, making an improper selection, failure to provide the requested information, or the like). In such situations, the system may be configured to initiate the presentation of a user interface on the automated machine (or in some embodiments the mobile phone in possession of the customer) with additional information and/or with an option to complete the rest of the transaction with a specialist associated with the business location. The system may then retain the preliminary information received from the customer, by the automated machine, and transfer the information to the video conference system to continue providing seamless service to the customer at the automated machine or direct the customer to a location of a video conference system (e.g., a terminal associated with the video conference system).

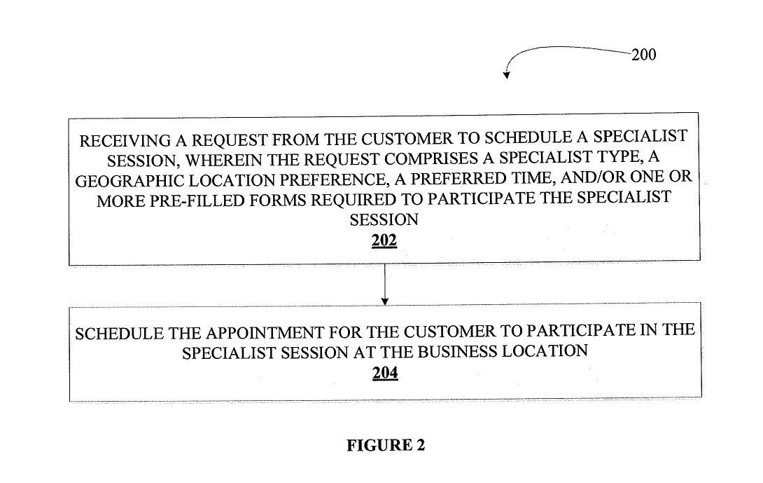

FIG. 2 presents a process flow to enable a customer to pre-register for a video conference system according to one aspect of the present invention 200. As shown in block 202, the process flow includes receiving a request from the customer to schedule a specialist session. In one aspect, the request may include a specialist type, a location preference, a preferred time, and/or one or more pre-filled forms required to participate in the specialist session. In one aspect, the specialist type may be associated with the nature of the service requested by the customer. For example, one or more specialist types may include, but are not limited to, a loan/mortgage specialist, investment banking specialist, treasury products specialist, wealth management specialist, retail banking specialist, commercial banking specialist, or the like. In addition, the customer may request a specific business center (e.g., geographic area, specific branch or terminal location, or the like), and a preferred time (e.g., date, time, duration, or the like). In another aspect, the customer, at the time of scheduling the appointment, may present one or more pre-filled forms and/or documents that may or may not be required to participate in the specialist session. In response to receiving the request, the process flow includes scheduling the appointment for the customer to participate in the specialist session based on the request submitted by the customer and the availability of the video conference systems at the requested locations or related locations, as shown in block 204.

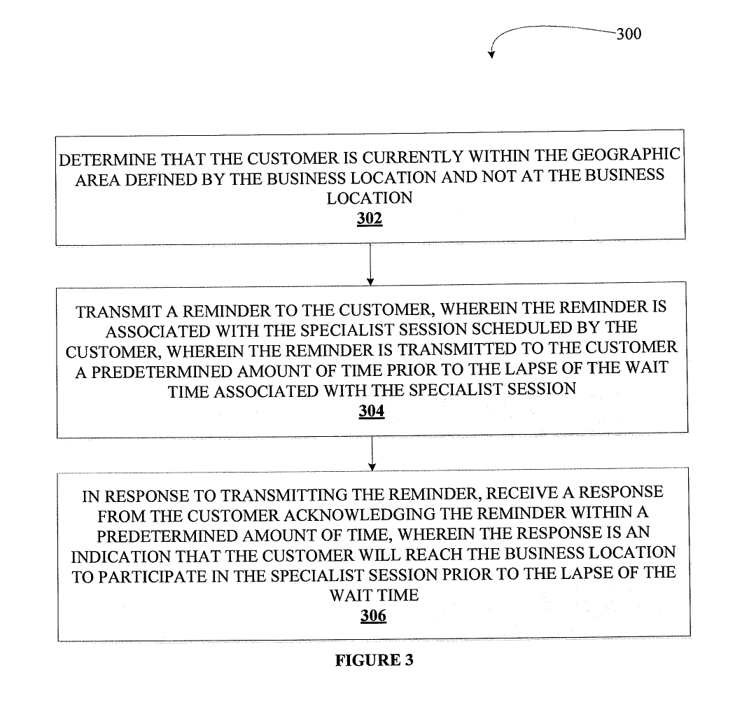

FIG. 3 presents a process flow to confirm the scheduled specialist session with the customer according to one aspect of the present invention 300. As shown in block 302, the process flow includes determining that the customer is currently within the area defined by the business location and not within the business location (or otherwise the customer may be within an area defined by the business location such a radius around the business, but located at another business that is within or overlaps the defined area). For example, the business location may be one of many businesses located in the same building or area (e.g., within a mall, block of a city, or the like). In some situations, the customer may want to visit a different business location (a restaurant, retail store, or the like) prior to visiting the business location to participate in the video conference system. In such cases, even though the mobile device in possession of the customer may be within the area defined by the business location prior to the scheduled appointment, the customer may have decided to visit a neighboring business prior to participating in the specialist session at the business that defined the area. In order to determine an accurate wait time, or for other reasons, it may be desirable for the business to know whether the customer identified within the area defined by the business location plans on visiting a different business location prior to visiting the business location to participate in the specialist session.

In some embodiments of the invention the business location may be defined by multiple defined areas. For example, there may be a first defined area that lets the business know that the customer is within a particular distance from the business location and a second defined area that lets the business know that the customer has actually arrived at the business location. As such, the business location may determine when to place the customer in the queue and also when the customer has arrived at the business location. In other embodiments multiple businesses within a first defined area may have individual defined areas that are shared in order to determine the location of the customer for adjusting the queue time, providing a new queue time, sending notification reminders, or the like as the customer moves between the individual defined areas within the first defined area (e.g., stores within a mall, sections within a store or warehouse, or the like).

In response to determining that the user is within one or more defined areas a reminder may be transmitted to the customer, wherein the reminder is associated with the specialist session scheduled for the customer, as shown in block 304. In one aspect, the reminder is transmitted to the mobile phone in possession of the customer a predetermined amount of time prior to the lapse of the wait time associated with the specialist session. The predetermined amount of time may be based on at least an average time to prepare the requisite forms and documents to prepare the customer to participate in the specialist session, an average wait time associated with the specialist type, and/or the geographic area defined by the business location. For example, the customer may enter the defined area which places the customer in a queue (e.g., in order prepare documents). In some embodiments a determination of the amount of time until the scheduled specialist session once the customer arrives may be made and included within the queue. Thereafter, as the queue counts down and is within a predetermined amount of time before the scheduled specialist session (e.g., 5 mins from the scheduled start time) a reminder may be sent to the customer. In one aspect, the reminder may be transmitted to the customer in the form of a pop up message, a text message, an email, alarm, visual indicator, or the like. In response to transmitting the reminder, the system may receive a response from the customer acknowledging the reminder within a predetermined amount of time (e.g., within 1 minute, or the like), wherein the response is an indication that the customer will reach the business location to participate in the specialist session prior to the lapse of the wait time, as shown in block 306.

In some embodiments of the invention if a specialist session is available before the scheduled time and/or before the wait time is up (e.g., the video terminal becomes available, the scheduled specialist has finished a previous meeting early, or the like), a notification may be provided to the user in the same way as described with respect to the reminder described above indicating that the specialist session may begin early (e.g., immediately, 2 minutes early, 5 minutes early, or the like). In some embodiments, when there is no specific scheduled time for the specialist session or the scheduled time is a time block (e.g., 30 minute block for the start time, or the like) a notification may be sent to the customer indicating that the specialist session may begin immediately or within a specific time. The specific time may be based on a predefined time period, an estimated time when the specialist or a terminal may be available, and/or or the distance the customer is away from the business location.

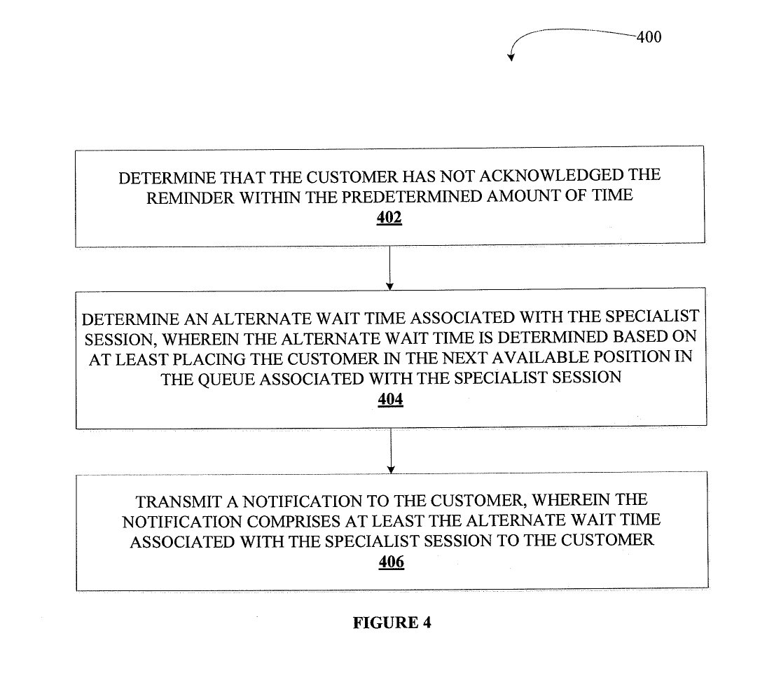

FIG. 4 illustrates a process flow for determining an alternate wait time associated with the specialist session according to one aspect of the present invention 400. As shown in block 402, the process flow includes determining that the customer has not acknowledged the reminder within the predetermined amount of time (e.g., the reminder described with respect to FIG. 3), has otherwise indicated that the he will not make the scheduled time, has left the defined area. For example, the customer may not have responded to the reminder or indicated that he would not make the scheduled time. In response, the process flow includes determining an alternate wait time associated with the specialist session based on at least placing the customer in the next available position in the queue associated with the specialist session, as shown in block 404. In some cases, the customer may have decided to visit a neighboring business location located within the area defined by the business location (or outside of the business location) prior to participating in the specialist session in the business location. In some situations, the customer may not be able to reach the business location in time to participate in the specialist session at the scheduled time. In these or other like scenarios, the system may be configured to determine an alternate wait time to ensure that there is minimal discrepancy in the service provided to the customer by the specialist.

In response to determining an alternate wait time, the process flow includes transmitting a notification to the customer, wherein the notification comprises at least the new scheduled time and/or alternate wait time associated with the specialist session to the customer, as shown in block 406. In some embodiments, the system may be configured to receive a response from the customer acknowledging that the alternate scheduled time and/or wait time is acceptable. In response to not receiving the acknowledgement from the customer after a predetermined amount of time, the system may again be configured to determine another alternate wait time (e.g., second, third, fourth, or the like wait time). In one aspect, the system may be configured to determine a specific number of alternate wait times for the customer, after which the customer's scheduled appointment may be cancelled.

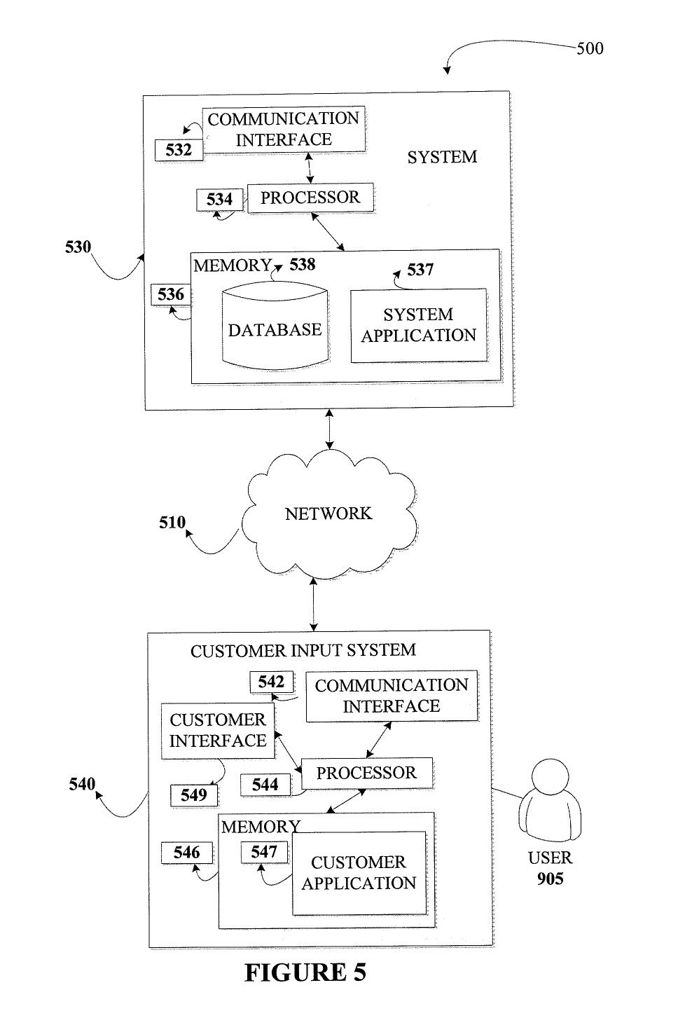

FIG. 5 presents an exemplary block diagram of the system environment 500 for implementing the process flows described herein in accordance with embodiments of the present invention. As illustrated, the system environment 500 includes a network 510, a system 530 (e.g., video conference system including a terminal, kiosk, automated teller and/or other systems through which the specialist session occurs), and a user input system 540 (e.g., the customer's mobile device). Also shown in FIG. 5 is a user (e.g., customer) of the user input system 540. The user input system 540 may be a mobile device or other non-mobile computing device. The user may be a person who uses the user input system 540 to execute a user application 547 (e.g., video conference application, scheduling application, location application, or the like, or combination thereof). The user application 547 may be an application to communicate with the system 530, perform a transaction or action, input information onto a user interface presented on the user input system 540, or the like. The user application 547 and/or the system application 537 (e.g., video conference application, scheduling application, location application, or the like, or combination thereof) may incorporate one or more parts of any process flow described herein.

As shown in FIG. 5, the system 530, and the user input system 540 are each operatively and selectively connected to the network 510, which may include one or more separate networks. In addition, the network 510 may include a telecommunication network, local area network (LAN), a wide area network (WAN), and/or a global area network (GAN), such as the Internet. It will also be understood that the network 510 may be secure and/or unsecure and may also include wireless and/or wired and/or optical interconnection technology.

The user input system 540 may include any computerized apparatus that can be configured to perform any one or more of the functions of the user input system 540 described and/or contemplated herein. For example, the user may use the user input system 540 to transmit and/or receive information or commands to and from the system 530. In some embodiments, for example, the user input system 540 may include a personal computer system (e.g. a non-mobile or non-portable computing system, or the like), a mobile computing device, a personal digital assistant, a mobile phone, a tablet computing device, a network device, and/or the like. As illustrated in FIG. 5, in accordance with some embodiments of the present invention, the user input system 540 includes a communication interface 542, a processor 544, a memory 546 having an user application 547 stored therein, and a user interface 549. In such embodiments, the communication interface 542 is operatively and selectively connected to the processor 544, which is operatively and selectively connected to the user interface 549 and the memory 546. In some embodiments, the user may use the user application 547 to execute processes described with respect to the process flows described herein. Specifically, the user application 547 executes the process flows described herein.

Each communication interface described herein, including the communication interface 542, generally includes hardware, and, in some instances, software, that enables the user input system 540, to transport, send, receive, and/or otherwise communicate information to and/or from the communication interface of one or more other systems on the network 510. For example, the communication interface 542 of the user input system 540 may include a wireless transceiver, modem, server, electrical connection, and/or other electronic device that operatively connects the user input system 540 to another system such as the system 530. The wireless transceiver may include a radio circuit to enable wireless transmission and reception of information. Additionally, the user input system 540 may include a positioning system. The positioning system (e.g. a global positioning system (GPS), a network address (IP address) positioning system, a positioning system based on the nearest cell tower location, or the like) may enable at least the user input system 540 or an external server or computing device in communication with the user input system 540 to determine the location (e.g. location coordinates) of the user input system 540.

Each processor described herein, including the processor 544, generally includes circuitry for implementing the audio, visual, and/or logic functions of the user input system 540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 547 of the memory 546 of the user input system 540.

Each memory device described herein, including the memory 546 for storing the user application 547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 546 includes the user application 547. In some embodiments, the user application 547 includes an interface for communicating with, navigating, controlling, configuring, and/or using the user input system 540. In some embodiments, the user application 547 includes computer-executable program code portions for instructing the processor 544 to perform one or more of the functions of the user application 547 described and/or contemplated herein. In some embodiments, the user application 547 may include and/or use one or more network and/or system communication protocols.

Also shown in FIG. 5 is the user interface 549. In some embodiments, the user interface 549 includes one or more output devices, such as a display and/or speaker, for presenting information to the user. In some embodiments, the user interface 549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 549 includes the input and display devices of a mobile device, which are operable to receive and display information.

FIG. 5 also illustrates a system 530, in accordance with an embodiment of the present invention. The system 530 may refer to the “apparatus” described herein. The system 530 may include any computerized apparatus that can be configured to perform any one or more of the functions of the system 530 described and/or contemplated herein. In accordance with some embodiments, for example, the system 530 may include a computer network, an engine, a platform, a server, a database system, a front end system, a back end system, a personal computer system, and/or the like. Therefore, the system 530 may be a server managed by the entity. The system 530 may be located at the facility associated with the entity or remotely from the facility associated with the entity. In some embodiments, such as the one illustrated in FIG. 5, the system 530 includes a communication interface 532, a processor 534, and a memory 536, which includes a system application 537 and a structured database 538 stored therein. As shown, the communication interface 532 is operatively and selectively connected to the processor 534, which is operatively and selectively connected to the memory 536.

It will be understood that the system application 537 may be configured to implement any one or more portions of the various user interfaces and/or process flow described herein. The system application 537 may interact with the user application 547. It will also be understood that, in some embodiments, the memory includes other applications. It will also be understood that, in some embodiments, the system application 537 is configured to communicate with the structured database 538, the user input system 540, or the like.

It will be further understood that, in some embodiments, the system application 537 includes computer-executable program code portions for instructing the processor 534 to perform any one or more of the functions of the system application 537 described and/or contemplated herein. In some embodiments, the system application 537 may include and/or use one or more network and/or system communication protocols.

In addition to the system application 537, the memory 536 also includes the structured database 538. As used herein, the structured database 538 may be one or more distinct and/or remote databases. In some embodiments, the structured database 538 is not located within the system and is instead located remotely from the system. In some embodiments, the structured database 538 stores information or data described herein.

It will be understood that the structured database 538 may include any one or more storage devices, including, but not limited to, datastores, databases, and/or any of the other storage devices typically associated with a computer system. It will also be understood that the structured database 538 may store information in any known way, such as, for example, by using one or more computer codes and/or languages, alphanumeric character strings, data sets, figures, tables, charts, links, documents, and/or the like. Further, in some embodiments, the structured database 538 may include information associated with one or more applications, such as, for example, the system application 537. It will also be understood that, in some embodiments, the structured database 538 provides a substantially real-time representation of the information stored therein, so that, for example, when the processor 534 accesses the structured database 538, the information stored therein is current or substantially current.

In some embodiments (not illustrated in FIG. 5), a specialist system is operatively coupled to the network 510 to communicate with the system 530, the user input system 540, and/or other systems. The specialist system has similar components as described with respect to the system 530 and/or the user input system 540, and as such operates and communicates with the other systems described herein in the same or similar way. The specialist system is used to allow the specialist to communicate with the customer over the video conference system.

It will be understood that the embodiment of the system environment illustrated in FIG. 5 is exemplary and that other embodiments may vary. As another example, in some embodiments, the system 530 includes more, less, or different components. As another example, in some embodiments, some or all of the portions of the system environment 500 may be combined into a single portion. Likewise, in some embodiments, some or all of the portions of the system 530 may be separated into two or more distinct portions.

In addition, the various portions of the system environment 500 may be maintained for and/or by the same or separate parties. It will also be understood that the system 530 may include and/or implement any embodiment of the present invention described and/or contemplated herein. For example, in some embodiments, the system 530 is configured to implement any one or more of the embodiments of the process flows described and/or contemplated herein in connection any process flow described herein. Additionally, the system 530 or the user input system 540 is configured to initiate presentation of any of the user interfaces described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### Method for Providing Customer Interaction-Focused Enhancements for Video Conference Systems

Personal contact still plays a role in the customer experiences, specifically for specialized transactions such as investment and loan counseling. Within the video conference systems customers are somewhat limited with respect to the type of interaction and level of interaction that exists between themselves the specialist.

As such additional embodiments of the invention are directed to systems, methods and computer program products for providing customer interaction-focused enhancements for video conference systems. The invention enables a user to establish a network connection between a video conference system and a user input system (e.g., mobile device of a user), where the video conference system is maintained by a financial institution, and where the user has an account with the financial institution. The system may then initiate a video conference session between a specialist associated with the video conference system and the user, and transmit data from the video conference system to the user, where the data is at least partially associated with the video conference session, and where the data is transmitted via a device integrated with the video conference system. In some embodiments described herein the “user” may be a “customer” as previously discussed herein.

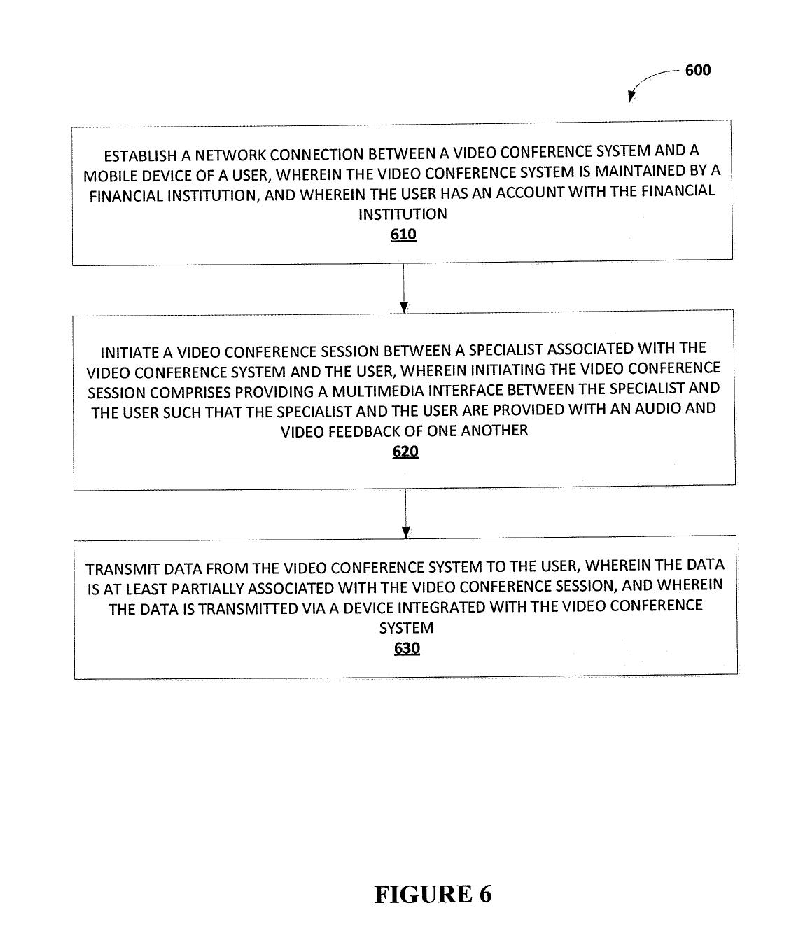

Referring now to FIG. 6, a high level process flow for providing customer interaction-focused enhancements for video conference systems 600 is illustrated in accordance with one embodiment of the present invention, which will be discussed in further detail throughout this specification. As illustrated in FIG. 6, the method may comprise a plurality of steps, including but not limited to, establishing a network connection between a video conference system and a user input system, where the video conference system is maintained by a financial institution and the user has an account with the financial institution 610, initiating a video conference session between a specialist associated with the video conference system and the user 620, and transmitting data from the video conference system to the user, where the data is at least partially associated with the video conference session and the data is transmitted via a device integrated with the video conference system 630.

The video conference system may include a customer-implemented video conference specialist apparatus that is located within a private setting in a business location, such that the user can communicate and exchange private information with the video conference system, and more specifically a specialist associated with the system and interacting with the user during the video conference session. In one specific example, the video conference specialist apparatus may be located within an enclosed office space at a financial institution, such as a banking center. In addition, the video conference specialist apparatus may include several integrated devices such as a display, a video camera, a speaker, and a microphone, all of which are configured to allow the user to communicate with and view the specialist as well as documents presented during the video conference session. The video conference system apparatus may operate a customer module that is configured to implement the display, the video camera, the speaker, and the microphone within the video conference system to conduct a video (and audio) communication session (e.g., a video chat session) with a specialist that is located physically remote from the business location at which the video conference system is located.

As represented by step 610, the system first establishes a network connection between a video conference system and a user input system. In an exemplary embodiment, the video conference system is maintained by an entity such as a financial institution and the user has an account with the financial institution.

In some embodiments, the established network connection between the video conference system and the user input system additionally facilitates a two-way communication system between the video conference system and the user input system. Through the two-way communication system, the video conference system is configured to send and receive data to and from the user input system, and the user input system is configured to send and receive data to and from the video conference system. In some embodiments, information is sent from the user input system and received at the video conference system in response to the video conference system sending a request for information/data to the user input system. For example, the specialist may request information from the user that may aid in authenticating the user's identity. The user input system may then send the video conference system one or more user authentication credentials in response to receiving the request. In some embodiments, information is sent from the video conference system and received at the user input system in response to the user sending a request for information/data. For example, the user may use the user input system to send a request for a particular set of forms to be received from the video conference system, and more specifically the associated specialist. In response to the request, the specialist may then send the forms to the user input system via the video conference system. The forms may additionally be sent automatically based on other factors presented within the video conference session without a need for external input from either the user or the specialist. In other embodiments, information may be exchanged between the video conference system the user input system on a continuous and/or semi-continuous basis. For example, the video conference system and the user input system may continuously exchange call/video log information related to the history of a video conference session that has been initiated between the video conference system and the user input system. In this way, a record or log of the session may be maintained on both the video conference system and the user input system.

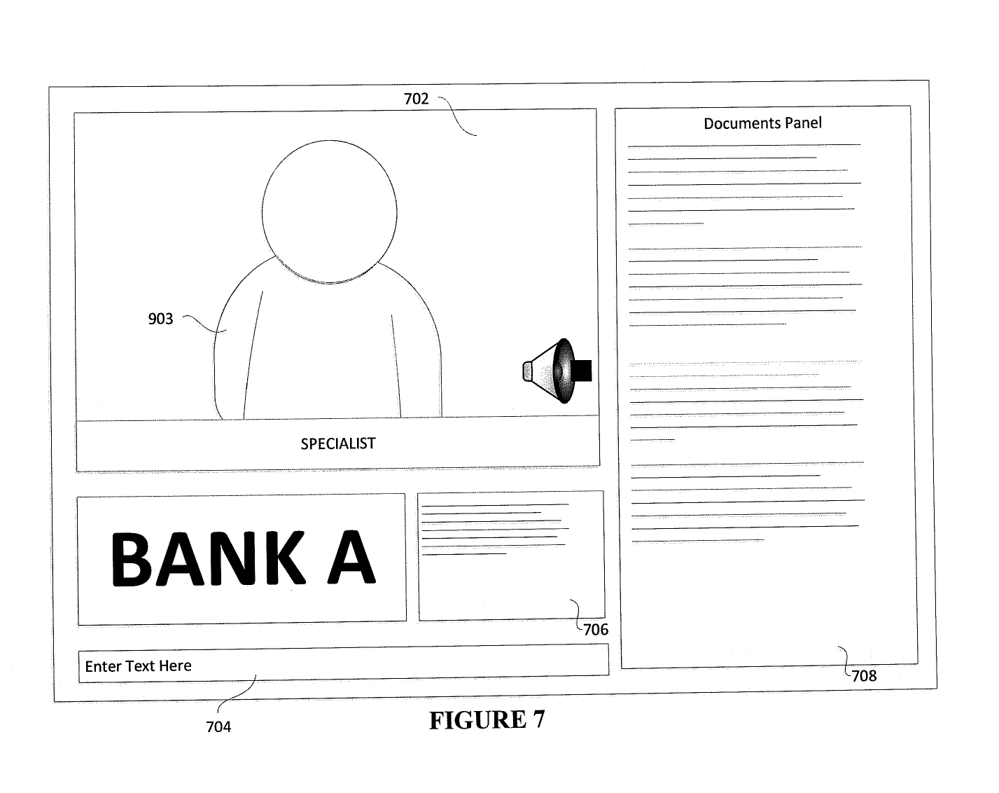

As represented by step 620, after establishing a connection between the specialist and the mobile device of the user, the system may then initiate a video conference session between a specialist associated with the video conference system and the user. Initiating the video conference session comprises providing a multimedia interface between the specialist and the user such that the specialist and the user are provided with an audio and video feedback of one another. As shown in FIG. 7, the video conference session may allow the user to communicate and/or view a specialist 903 via a video and/or audio feed 702 presented on a display within the video conference system. Through the display, the user may have access to a range of functions including chatting capabilities through text input boxes 704 and dialogue boxes 706, and the ability to review information presented by the specialist via document presentation panels 708.

In some embodiments, initiating a video conference session between a specialist associated with the video conference system and the user may further comprise first authenticating the user's identity. In an exemplary embodiment, the authentication is based at least partially on user input or general information that verifies that the user is an account holder of the financial institution. The user input or general information may be received from the mobile device via the established network connection. The user input or general information may typically comprise one or more authentication credentials associated with the user. The requested and/or received authentication credentials may vary based on the type of video conference session being initiated, and more specifically the type of transactions that the user may complete (or is expected to complete) throughout the session. In this way, numerous types and levels of user authentication may exist, and the user may be initially authenticated for a primary level of access to conduct general transactions within the video conference session, and the user may be required to provide a subsequent stricter authentication in an instance where a need exist to conduct a transaction that is not provided within the primary level of access received. For example, the primary level of access may include the user being able to verify that they are an account holder with the entity (e.g. financial institution) by providing an account number and related password such that the user is able to interface with a specialist and ask questions about loan options that the financial institution offers. In an event that the user decides to apply for a loan while within the video conference session, the user may be required to provide additional authentication credentials, such as a social security number, prior to being sent a loan application form. In some embodiments, the received authentication credentials may be used by the specialist and/or the video conference system to prepare documents (e.g. a loan application) for use within the video conference session. The user authentication credentials that may be sent via the mobile device may include, but not be limited to, a username, password, account number, full-length social security number or partial digits, challenge questions, familiar pictures and/or phrases, biometrics, key fob-based alphanumeric codes, and the like. In some embodiments, the user authentication credentials are explicitly provided by the user, and in other embodiments the user authentication credentials are stored within the user's mobile device and automatically transferred, in response to a request, to the video conference system on the user's behalf.

In an alternate embodiment, the user's identity is authenticated prior to establishing a secured network connection. In such an embodiment, the system may first establish a general and/or unsecured network connection with the mobile device solely for the purpose of authenticating the user's identity. Information transmitted through the unsecured network connection, such as sensitive user information maintained within user authentication credentials, may be required to be encrypted prior to being sent from the mobile device to the video conference system. As such the mobile device may separately send a decryption key to the video conference system. After the user has been authenticated and the user's identity has been subsequently verified, the system may then establish a secure network connection between the video conference system and the mobile device of the user such that sensitive information (e.g. user financial data) may be transmitted through the secured network connection without requiring encryption prior to being sent each time the sensitive information is transmitted.

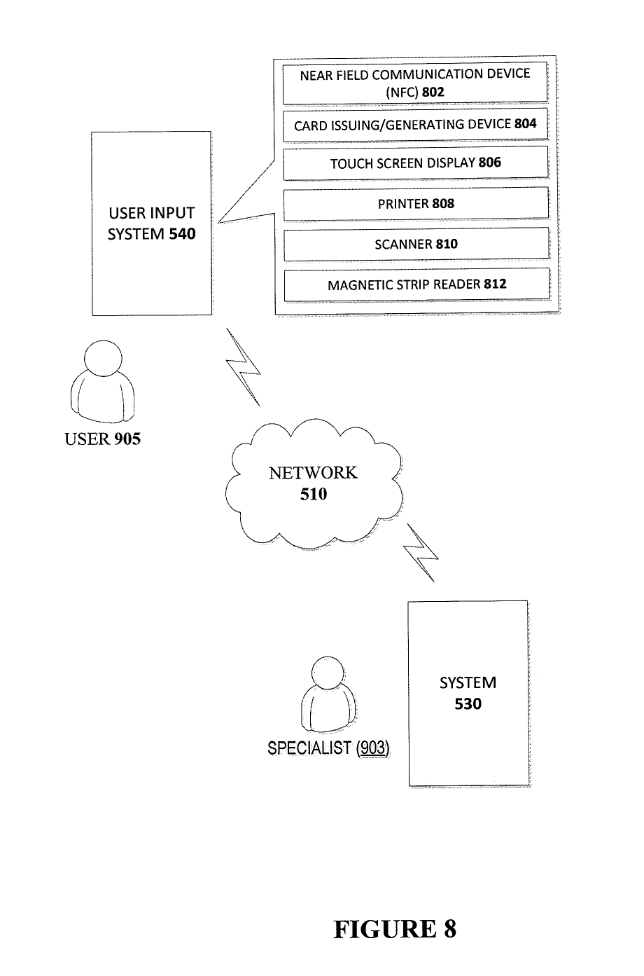

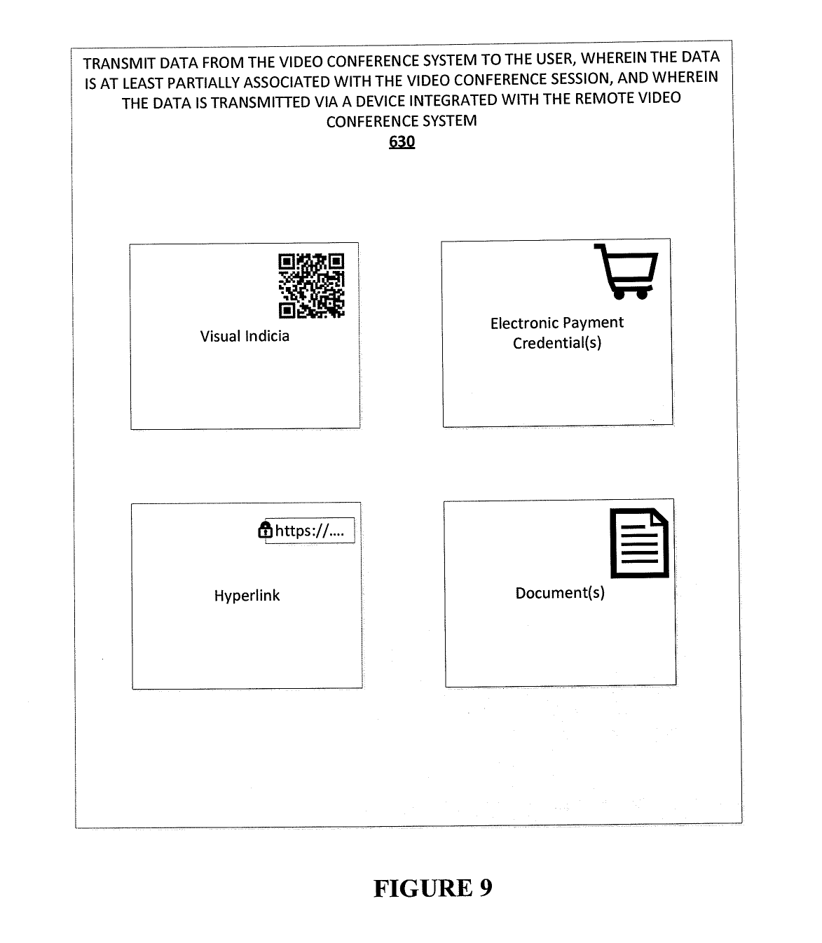

As represented by step 630, after initiating a video conference session between a specialist associated with the video conference system and the user, the system may additionally transmit data from the video conference system to the user. In an exemplary embodiment, the data is at least partially associated with the video conference session and transmitted via a device integrated within the video conference system. As shown in FIG. 8, the user input system 540 may be integrated with several devices that allow the user to directly interact with the video conference system 530 and the specialist 903 through the network 510. The optionally integrated devices, may include but are not be limited to Near Field Communication (NFC) device 802, card issuance device(s) 804, touch screen displays 806, printer(s) 808, scanner(s) 810, magnetic stripe reader(s) 812, and/or the mobile device of the user 904, all of which may be discussed in further detail herein. In some embodiments, these devices may be integrated directly with the user input system 540. In some other embodiments, one or more of the devices may be integrated with the user input system 540 indirectly. In this regard, these devices may be available as part of the business environment, connected to the user input system 540 by virtue of a network. As further shown in FIG. 9, the video conference system may be configured to transmit and/or receive various types of data including, but not limited to, visual indicia, electronic payment credentials, general documents, hyperlinks, and the like, all of which may be discussed in further detail herein.

In some embodiments, the device integrated within the user input system 540 is a Near Field Communication (NFC) device 802. In such an embodiment, the two-way communication system between the user input system 540 and the video conference system 530 is embodied by an NFC communication system. The user input system 540 may be embedded with an NFC chip that is configured to allow communication and data transfer between the user input system 540 and the video conference system. In some embodiments, this implementation requires that an NFC device 802 associated and/or integrated with the user input system 540 be within an appropriate range or distance (e.g. 10 centimeters or less) of a corresponding receiver (not shown in the figure) capable of receiving data using an NFC device installed therein and transmitting the received data through the network 510 to the video conference system 530. For example, the receiving device may be a touch pad that contains the NFC chip and serves as a specific location that a user may contact with the user input system 540 for the purpose of sending and/or receiving information to the video conference system through the network 510. For example, the user may have a preexisting authentication token stored on their user input system 540 such that when contacting the touch pad containing the NFC chip, the authentication information is transmitted from the user input system 540 to the video conference system through the network 510, and the user's identity is subsequently authenticated upon receipt of the information. In such an embodiment, the user input system 540 may be embodied by any device that is capable of having NFC chips embedded therein, including but not limited to, mobile phones, credit/debit cards.

In some embodiments, the device integrated within the user input system 540 is a card issuance device 804. For example, the user may have access to a magnetic stripe writer/encoder integrated therein. In such an embodiment, the specialist may issue and generate either temporary or permanent debit card, credit cards, internal identification cards, or the like from within a video conference session by transmitting information to the card issuance device 804 through the network 510 to be written/encoded onto a magnetic stripe. It should be noted that the specialist may issue and generate other physical card mediums that do not contain a magnetic stripe or require encoded information prior to being issued (e.g. general identification cards) by transmitting information to the card issuance device 804 through the network 510. In some embodiments, the user input system 540 includes a storage area that contains blank magnetic stripe cards and can subsequently write information to the cards and issue them to the user based on a request made by the user. For example, the user may apply and receive approval for a new credit card during a video conference session with a specialist. The specialist may then transmit information to the integrated magnetic stripe encoder to generate the user a temporary credit card that may be used in the interim while the user waits to receive a permanent credit card via mail or another means. In some embodiments, the user input system 540 may further configured to erase information from magnetic stripe cards in addition to encoding information within the magnetic stripe using the card issuance device 804. For example, the user may report an instance of identity theft during the video conference session. The video conference system may then receive the user's current credit and/or debit cards through the card issuance device 804 and erase the information contained within the magnetic stripe and additionally shred the physical cards in some instances. In such an embodiment, the user input system 540 may be integrated with additional hardware to accomplish these tasks such as a card shredder. As previously mentioned, the user input system 540 may then utilize the integrated magnetic stripe encoder to generate the user a temporary credit card that may be used in the interim while the user waits to receive a permanent credit card.

In some embodiments, the device integrated within the user input system 540 is a touch screen display 806. In such an embodiment, the specialist may be configured to present information to the user via the network 510, to the touch screen display 806 such that the user is able to physically interact with documents presented and additionally send information to the specialist through option selections presented on the touch screen display 806. For example, the user may be requesting information about loan options that are offered by the financial institution or another entity associated with or responsible for maintaining the video conference system. Documents that outline detailed information related to the loan options may then be presented on the touch screen display 806 such that the user can scroll through the presented documents and additionally highlight and/or annotate portions of that document that he/she has questions about. The modified document (e.g. the document including the highlighted portions) may then be sent back to the specialist, or may be visible to the specialist in real-time, such that the user and the specialist may continue to discuss the user's questions while both having a common visual aid. In an alternative embodiment, the specialist may be configured to broadcast the information to be presented onto a touch screen display 806 or general display associated with the user input system 540.

In some embodiments, the device integrated within the user input system 540 is a printing device 808. In such an embodiment, the specialist may provide the user with hard copies of documents discussed and/or presented electronically throughout the video conference session by sending a command to the printing device 808 through the network 510. In some embodiments, in addition to sending a command to the printing device, the specialist may transmit a notification to an employee in the business environment indicating that the hard copies of documents from the printing device 808 need to be presented to the user participating in the video conference session. The documents may include but are not be limited to, disclosure forms, call/video conference session logs, information pamphlets, and the like. For example, the user may review several disclosure forms throughout the video conference session, and in some instances the user may additionally provide an electronic signature on at least one of the forms presented. After the session has completed, or at any point in time during the session the video conference system may initiate a print command at the user input system 540 to retrieve a copy of the forms presented such that the copies additionally include the user's electronic signature and any other notes provided by the specialist. As an alternative to providing an electronic signature document, the forms may additionally be printed for the purpose of allowing the user to physically sign a hard-copy of the document. In such an instance, the user input system 540 may print copies of any document that require a signature by the user either during or after the video conference session. The user may then return the signed documents to the specialist via hardware or drop boxes integrated with the video conference system or by another means. For example, the user input system 540 may have a mail drop box such that the user may sign and deposit the documents within the drop box to be subsequently mailed to the specialist (or scanned and sent through the video conference system).

In some embodiments, the device integrated within the user input system 540 is a scanning device 810. In such an embodiment, the video conference system may be configured to receive and create electronic copies of documents discussed and/or presented throughout the video conference session from the user input system 540. The documents may include but not be limited to, disclosure forms, user identification, checks or other payment instruments and the like. For example, the user may receive several printed disclosure forms throughout the video conference session, and in some instances the user may additionally be required to provide a wet signature on at least one of the forms presented. After the session has completed, or at any point in time during the session the scanning device 810 integrated with the user input system 540 may scan and receive the user's signed copies of the disclosure forms. In some embodiments, the scanning device 810 may be configured to aid in user authentication as discussed previously herein. In such an embodiment, the scanning device 810 may be a biometric scanner that is configured to scan a plurality of biometrics associated with the user including, but not limited to, finger prints, retinal images, and the like. For example, the video conference system may request that the user scan a valid biometric prior to either initiating a video conference session or securely connecting the user input system 540 to the video conference system. The scanned biometric image may then be either transferred to the specialist for authentication or automatically verified by the video conference system such that the user's identity is subsequently authenticated upon receipt of the scanned biometric image.

In some embodiments, the device integrated within the user input system 540 is a magnetic stripe reading device 812. In such an embodiment, the user input system 540 may be configured to electronically receive information associated with debit cards, credit card, and other similar payment instruments and transmitted to the video conference system through the network 510. In some embodiments, the magnetic stripe reader is utilized such that the video conference system may accept user payments during the video conference session. For example, the user may be signing up for a new service, providing a deposit towards an approved home owners loan or automotive loan, or involved in another instance that requires the specialist to receive a payment of some sort from the user. After the session has completed, or at any point in time during the session the video conference system may receive the user(s) payment by scanning the associated magnetic stripe via the magnetic stripe reader 812 integrated within the user input system 540. In some embodiments, the magnetic stripe reading device 812 may be configured to aid in user authentication as discussed previously herein. For example, the specialist or the video conference system may request that the user swipe a valid credit or debit card associated with the entity responsible for maintaining the video conference system prior to either initiating a video conference session or securely connecting the user input system 540 to the video conference system. In response to swiping his/her's card through the magnetic stripe reader 812 various authentication credentials may then be either transferred to the specialist for authentication or automatically verified by the video conference system such that the user's identity is subsequently authenticated upon receipt of the information.

In some embodiments, the device integrated within the user input system 540 is an electronic and/digital signature pad. In such an embodiment, the video conference system may be configured to receive electronic signatures on behalf of the user. In some embodiments, the magnetic stripe reader is utilized such that the video conference system may accept user payments during the video conference session from the user input system 540 through the network 510. For example, the user may be presented with several documents throughout the video conference session, and in some instances the user may additionally be required to provide an electronic signature on at least one of the documents presented. After the session has completed, or at any point in time during the session the video conference system may receive the users electronically signed copies of the documents. In some embodiments, the digital signature pad may be configured to aid in user authentication as discussed previously herein. For example, the specialist or the video conference system may request that the user provide their signature via the electronic signature pad prior to either initiating a video conference session or securely connecting the user input system 540 to the video conference system. In response to providing their digital signature an electronic image of the signature may then be either transferred to the specialist for authentication or automatically verified by the video conference system in comparison to a signature from a document that was physically signed within a branch location, for example, such that the user's identity is subsequently authenticated upon receipt of the digital signature.

In some embodiments, the data transmitted from the video conferencing system to the user may include a form of visual indicia. The visual indicia may be presented, for example, on a display integrated within the user input system 540 or printed, as previously discussed herein. The visual indicia may include, but not be limited to, a barcode, Quick Response (QR) code, hologram, and the like. In some embodiments, in response to the user scanning the visual indicia with the user input system 540 he/she may receive additional documentation that is related to the video conference session. For example, the user may be presented a QR code on a display to the user input system 540 and further instructed to scan the QR code. Upon scanning the QR code the user may be transmitted an electronic disclosure form, electronic information pamphlet, a payment token for use within a digital wallet, an electronic copy of the session log, and/or the like. In some embodiments, the visual indicia may be used to leverage an existing user authentication or general check-in process within the video conference system. For example, the user may scan a QR code that is temporarily or permanently displayed at the user input system 540 when initially entering and prior to initiating a video conference session. In response to scanning the QR code, the video conference system may automatically obtain access to authentication credentials that are stored on the user input system 540 (e.g. within a mobile banking application stored on the user's mobile device), request the user provide authentication credentials, or a general description of their current purpose for the video conference session.

In some embodiments, the data transmitted from the video conference system to the user may include an electronic payment credential. As used herein “token” (e.g., an alias, substitute, surrogate, or other like identifier) may refer to a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the Internet instead of using a physical payment device. In one embodiment the electronic payment credential may be a token that the video conference system is configured to provision for use within a digital wallet maintained on the user's mobile device. For example, the user may apply and receive approval for a new credit card during a video conference session. The video conference system may then transmit a token to the user's mobile device that is associated with the newly issued credit card number and provisioned for temporary or permanent use within the user's digital wallet until a physical card arrives in the mail.

In some embodiments, the data transmitted from the video conference system to the user may include one or more disclosure forms, applications, or general documents on behalf of the entity. The disclosure forms may include, but not be limited to, account disclosures (e.g. savings account, checking accounts), loan disclosures, shipping document fees disclosure, form and copies disclosure statements, and the like. For example, the user may open a new account with an entity (e.g. financial institution) during a video conference session. The video conference system may then electronically transmit a disclosure form associated with the new account to the user.

In some embodiments, the data transmitted from the video conference system to the user may include a hyperlink. In such an embodiment, the hyperlink may be transferred directly to the user input system 540. The hyperlink may reference documents discussed during the video conference session, requiring later signature, additional steps that the user should follow through with after the video conference session, and the like. The documents may be maintained on a website or server associated with the entity responsible for maintaining the video conference system and/or a third party. In some embodiments, the hyperlink is active for a predetermined period of time allowing the user to access the documents either for printing for their personal record, signing and returning to an appropriate entity, or general record of the documents. For example, the user may enter a video conference system and engage in several orders of business. After the video conference session ends, the video conference system may then electronically transmit a hyperlink that references an electronic record or transcription of the video conference session that is accessible for five (5) days (or any other number of days, hours, minutes, or the like) after being sent.

In some embodiments, in addition to the data transmitted from the video conference system to the user, the data may be additionally transmitted from the video conference system to a relevant third party. For example, the user may apply for and receive approval for an automotive loan during a video conference session. After the video conference session ends, the video conference system may then electronically transmit information related to the user's approval to local dealerships. In this way, the entity responsible for maintaining the video conference session may be able to facilitate additional discounts or incentives for the user based at least partially upon their preexisting relationships with various companies.

In some embodiments, as previously discussed herein, in addition to transmitting data from the video conference system to the user, the video conference system is also configured to receive data directly from the user via the user's mobile device. In an exemplary embodiment, the data is at least partially associated with the video conference session and the mobile device may be considered a device integrated within the video conference system due to a previously established network connection between the mobile device of the user and the video conference system. To this extent, it should be noted that the mobile device may similarly carry out any functions previously discussed herein with reference to data transmission using a device integrated within the video conference system, or vice versa. For example, the mobile device may similarly transfer forms, documents, user credentials, and the like to the video conference system. Likewise, the data may be directly transmitted from the video conference system and displayed on the mobile device of the user. Methods of data transmission to the user, or more specifically, the user's mobile device may include, but not be limited to email, text messaging, multimedia messaging, or other methods for digitally sharing content that have not been expressly contemplated herein.

In some embodiments, the mobile application is configured to interact with the video conference system through an application or graphical user interface (GUI) that is associated with the video conference system. Through the application or GUI the user may be able to directly interact with the video conference system either based on broadcasted touch-pad/display prompts, voice commands, or another means. In one embodiment, the application or GUI is temporarily stored on the user's mobile device. For example, the application may be launched on the user's mobile device in response to a network connection being between a video conference system and a mobile device of the user. In one embodiment, the application or GUI is permanently stored on the user's mobile device. For example, the application may be associated with the user mobile banking application and manually launched on the user's mobile device after a network connection being between a video conference system and a mobile device of the user.

In some embodiments, the data transmitted from the mobile device of the user to the video conference system may include one or more prefilled forms. For example, the user may download a blank form from various sources prior to initiating video conference session or entering a video conference system, the user may then fill out the form and upload prefilled forms directly from the mobile device to the video conference system, thus saving time within the video conference session. In other embodiments, the user may receive a prefilled form from the video conference system that includes a portion of the required information that is known to the specialist (e.g. name, address date of birth), fill in the remaining information, and send the completed form back to the video conference system.

In some embodiments, the data transmitted from the mobile device of the user to the video conference system may include one or more digital images. The images may be associated with various file extensions configured to be maintained on the user's mobile device including, but not limited to, jpeg, tiff, raw, gif, bmp, png, and the like. For example, the user may send the video conference system digital images of documents that have been either captured by the mobile device or are stored on the mobile device in alternative to faxing or scanning the documents to the specialist.

The video conference system may be additionally configured to provide a record log of the video conference session between a user and the specialist that outlines the history of the video conference session. The log may contain various items of information including, but not limited to, documents presented, topics discusses, a list of attendees, video clips, call transcriptions, and the like. The record log may then be communicated to the user using various methods discussed herein. In some embodiments, the record log may be stored directly on the user's mobile device for their permanent record.

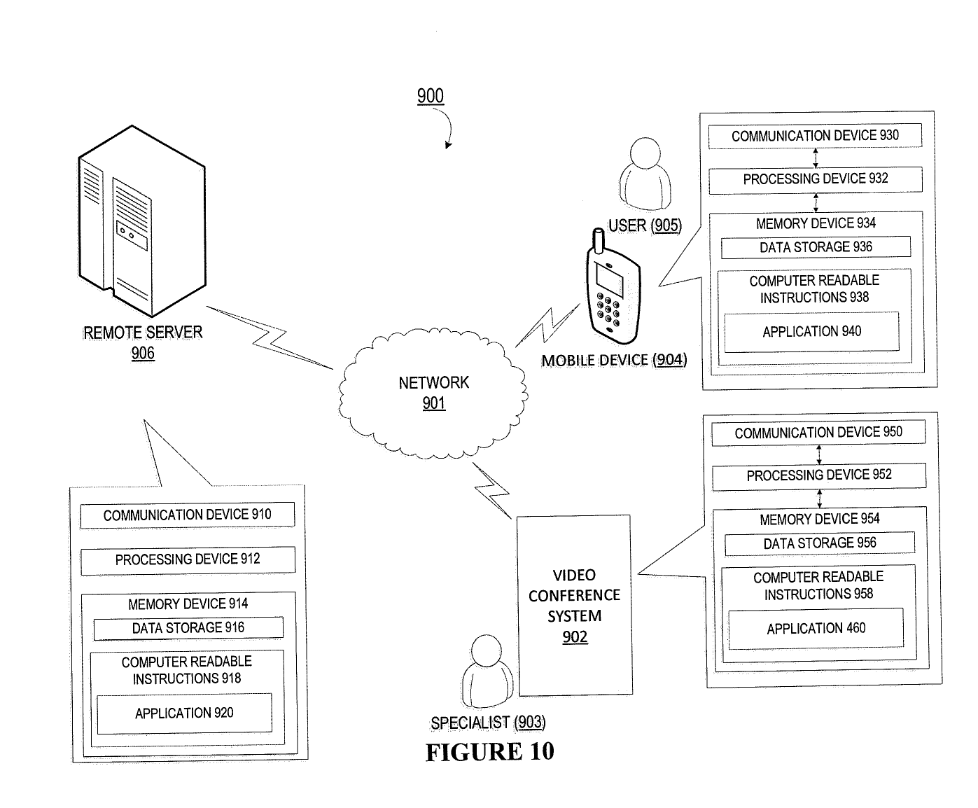

Referring to FIG. 10, a network environment is illustrated in accordance with embodiments of the present invention. As illustrated in FIG. 10, the video conference system 902 is operatively coupled via a network 901 to the user's mobile device 904 and/or a remote server 906. In this configuration, the video conference system 902 may send information to and receive information from the user's mobile device 904 and/or the remote server 906. Additionally, the user's mobile device 904 may send and receive communications directly from the remote server 906. The video conference system 902 may be or include one or more network base stations or other network components. FIG. 9 illustrates only one example of an embodiment of a video conference system network environment 900, and it will be appreciated that in other embodiments one or more of the systems, devices, or servers may be combined into a single system, device, or server, or be made up of multiple systems, devices, or server.

The network 901 may be a global area network (GAN), such as the Internet, a wide area network (WAN), a local area network (LAN), a telecommunication network or any other type of network or combination of networks. The network 901 may provide for wire line, wireless, or a combination wire line and wireless communication between devices on the network 901.

In some embodiments, the user 905 is an individual who has initiated a session with the video conference system, and the specialist 903 is personnel associated with the entity (e.g. financial institution) responsible for maintaining the video conference system.

As illustrated in FIG. 10, the video conference system 902 generally comprises a communication device 950, a processing device 952, and a memory device 954. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combination of the foregoing. Control and signal processing functions of the system are allocated between these processing devices according to their respective capabilities. The processing device may include functionality to operate one or more software programs based on computer readable instructions thereof, which may be stored in a memory device.

The processing device 952 is operatively coupled to the communication device 950 to communicate with the network 901 and other devices on the network 901. As such, the communication device 950 generally comprises a modem, server, or other device for communicating with other devices on the network 901.

As further illustrated in FIG. 10, the network video conference system 902 comprises computer readable instructions 958 of an application 960. In some embodiments, the memory device, 954 includes data storage 956 for storing data related to and/or used by the application 960. The application 960 may perform one or more of the steps and/or sub-steps discussed herein and/or one or more steps not discussed herein. For example, in some embodiments, the application 960 may provide detailed information about one or more items of interest to the user's mobile device 904.

As illustrated in FIG. 10, the user's mobile device 904 generally comprises a communication device 930, a processing device 932, and a memory device 934. The processing device 932 is operatively coupled to the communication device 930 and the memory device 934. In some embodiments, the processing device 932 may send or receive data from the user's mobile device 904, to the video conference system 902 via the communication device 930 over a network 901. As such, the communication device 930 generally comprises a modem, server, or other device for communicating with other devices on the network 901.

As further illustrated in FIG. 10, the user's mobile device 904 comprises computer readable instructions 938 stored in the memory device 934, which in one embodiment includes the computer-readable instructions 938 of an application 940. In the embodiment illustrated in FIG. 8, the application 940 allows the user's mobile device 904 to be linked to the video conference system 902 to communicate, via a network 901. The application 940 may also allow the user's mobile device 904 to connect directly (i.e. locally or device to device) with the remote server 906 for sending and receiving information. The application 940 may perform one or more of the steps and/or sub-steps discussed herein and/or one or more steps not discussed herein. For example, in some embodiments, the application 940 may receive information to be presented on a display within the user's mobile device. In some embodiments the application 940 may be a dedicated application (e.g., app for the video conference system) or an indirect application 940 (e.g., browser that allows the user to access the video conference system in a website, portal, or the like) that can be used to access the video conference system.

As illustrated in FIG. 10, the remote server 906 may include a communication device 910, a processing device 912, and a memory device 914. The processing device 912 is operatively coupled to the communication device 910 and the memory device 914. In some embodiments, the processing device 912 may send or receive data from the user's mobile device 904 and/or the video conference system 902 via the communication device 910. Such communication may be performed either over a direct connection and/or over a network 901. As such, the communication device 910 generally comprises a modem, server, or other device for communication with other devices on the network 901.

As further illustrated in FIG. 10, the remote server 906 comprises computer-readable instructions 918 of an application 920. In the embodiment illustrated in FIG. 9, the application 920 allows the database 906 to be linked to the video conference system 902 to communicate, via a network 901. The application 920 may also allow the user's mobile device 904 to connect directly (i.e., locally or device to device) with the remote server 906 or indirectly through the network 901. The application 920 may perform one or more of the steps and/or sub-steps discussed herein and/or one or more steps not discussed herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system to enable a customer to check-in for a specialist session, the system comprising:
at least one memory device having computer readable program code store thereon; and
at least one processing device operatively coupled to the at least one memory device, wherein the at least one processing device is configured to execute the computer readable program code to:
receive an indication that a customer has an appointment scheduled to participate in a specialist session at a business location;
determine that a mobile device in possession of the customer is located within an area defined by the business location and is associated with the business location; and
place the customer in a queue associated with the specialist session in response to determining that the mobile device is located within the area defined by the business location.

2. The system of claim 1, wherein the at least one processor is further configured to execute the computer readable program code to:
receive information from the customer, wherein the mobile device in possession of the customer is located within the area defined by the business location but not located at the business location, wherein the information received from the customer is associated with the specialist session;
determine that the customer has entered the business location; and
transfer the information received from the customer to the video conference system for the specialist session.

3. The system of claim 1, wherein the at least one processor is further configured to execute the computer readable program code to:
schedule the appointment for the customer to participate in the specialist session at the business location, wherein scheduling further comprises receiving a request from the customer to schedule the specialist session, wherein the request comprises a specialist type, a geographic location preference, a preferred time, and/or one or more pre-filled forms required to participate the specialist session.

4. The system of claim 1, wherein the at least one processor is further configured to execute the computer readable program code to:
initiate a presentation of a user interface on the mobile device, wherein the user interface enables the customer to provide a confirmation that the customer is located within the area defined by the business location.

5. The system of claim 1, wherein the at least one processor is further configured to execute the computer readable program code to:
authenticate the customer prior to placing the customer in the queue, wherein authenticating the customer comprises:
receiving one or more authentication credentials associated with the customer;
comparing the one or more received authentication credentials to the one or more authentication credentials associated with the customer stored in a database to determine a match; and
authenticating the customer to be placed in the queue in response to determining the match.

6. The system of claim 5, wherein the at least one processor is further configured to execute the computer readable program code to:
provide a notification to the customer based on at least a successful authentication, wherein the notification comprises at least one of a direction to the video conference system at the business location, a wait time associated with the specialist session, and/or information associated with a specialist participating in the specialist session.

7. The system of claim 1, wherein the at least one processor is further configured to execute the computer readable program code to:
determine that the customer is currently within the area defined by the business location, but not at the business location;
transmit a reminder to the customer, wherein the reminder is associated with the specialist session scheduled by the customer, wherein the reminder is transmitted to the customer a predetermined amount of time prior to the lapse of a wait time associated with the specialist session; and
receive a response from the customer acknowledging the reminder within a predetermined amount of time in response to transmitting the reminder, wherein the response is an indication that the customer will reach the business location to participate in the specialist session prior to the lapse of the wait time.

8. The system of claim 7, wherein the at least one processor is further configured to execute the computer readable program code to:
determine that the customer has not acknowledged the reminder within the predetermined amount of time;
determine an alternate wait time associated with the specialist session, wherein the alternate wait time is determined based on at least placing the customer in the next available position in the queue associated with the specialist session; and
transmit a notification to the customer, wherein the notification comprises at least the alternate wait time associated with the specialist session to the customer.

9. A computing program product to enable a customer to check-in for use in a specialist session, the computer program product comprising at least one non-transitory computer-readable medium having computer-readable program code portions embodied therein, the computer-readable program code portions comprising:
an executable portion configured to receive an indication that a customer has an appointment scheduled to participate in a specialist session at a business location;
an executable portion configured to determine that a mobile device in possession of the customer is located within an area defined by the business location and is associated with the business location; and
an executable portion configured to place the customer in a queue associated with the specialist session in response to determining that the mobile device is located within the area defined by the business location.

10. The computer program product of claim 9, wherein the computer-readable program code portions further comprise:
an executable portion configured to receive information from the customer, wherein the mobile device in possession of the customer is located within the area defined by the business location but not located at the business location, wherein the information received from the customer is associated with the specialist session;
an executable portion configured to determine that the customer has entered the business location; and
an executable portion configured to transfer the information received from the customer to the video conference system for the specialist session.

11. The computer program product of claim 9, wherein the computer-readable program code portions further comprise:
an executable portion configured to schedule the appointment for the customer to participate in the specialist session at the business location, wherein scheduling further comprises receiving a request from the customer to schedule the specialist session, wherein the request comprises a specialist type, a geographic location preference, a preferred time, and/or one or more pre-filled forms required to participate the specialist session.

12. The computer program product of claim 9, wherein the computer-readable program code portions further comprise:
an executable portion configured to initiate a presentation of a user interface on the mobile device, wherein the user interface enables the customer to provide a confirmation that the customer is located within the area defined by the business location.

13. The computer program product of claim 9, wherein the computer-readable program code portions further comprise:
an executable portion configured to authenticate the customer prior to placing the customer in the queue, wherein authenticating the customer comprises:
receiving one or more authentication credentials associated with the customer;
comparing the one or more received authentication credentials to the one or more authentication credentials associated with the customer stored in a database to determine a match; and
authenticating the customer to be placed in the queue in response to determining the match.

14. The computer program product of claim 13, wherein the computer-readable program code portions further comprise:
an executable portion configured to provide a notification to the customer based on at least a successful authentication, wherein the notification comprises at least one of a direction to the video conference system at the business location, a wait time associated with the specialist session, and/or information associated with a specialist participating in the specialist session.

15. The computer program product of claim 9, wherein the computer-readable program code portions further comprise:
an executable portion configured to determine that the customer is currently within the area defined by the business location, but not at the business location;
an executable portion configured to transmit a reminder to the customer, wherein the reminder is associated with the specialist session scheduled by the customer, wherein the reminder is transmitted to the customer a predetermined amount of time prior to the lapse of a wait time associated with the specialist session; and
an executable portion configured to receive a response from the customer acknowledging the reminder within a predetermined amount of time in response to transmitting the reminder, wherein the response is an indication that the customer will reach the business location to participate in the specialist session prior to the lapse of the wait time.

16. The computer program product of claim 15, wherein the computer-readable program code portions further comprise:
an executable portion configured to determine that the customer has not acknowledged the reminder within the predetermined amount of time;
an executable portion configured to determine an alternate wait time associated with the specialist session, wherein the alternate wait time is determined based on at least placing the customer in the next available position in the queue associated with the specialist session; and
an executable portion configured to transmit a notification to the customer, wherein the notification comprises at least the alternate wait time associated with the specialist session to the customer.

17. A method to enable a customer check-in for a specialist session, the method comprising:
receiving, by a processing device, an indication that a customer has an appointment scheduled to participate in a specialist session at a business location;
determining, by a processing device, that a mobile device in possession of the customer is located within an area defined by the business location and is associated with the business location; and
placing, by a processing device, the customer in a queue associated with the specialist session in response to determining that the mobile device is located within the area defined by the business location.

18. The method of claim 17, further comprising:
receiving, by a processing device, information from the customer, wherein the mobile device in possession of the customer is located within the area defined by the business location but not located at the business location, wherein the information received from the customer is associated with the specialist session;
determining, by a processing device, that the customer has entered the business location; and
transferring, by a processing device, the information received from the customer to the video conference system for the specialist session.

19. The method of claim 17, further comprising:
determining, by a processing device, that the customer is currently within the area defined by the business location, but not at the business location;
transmitting, by a processing device, a reminder to the customer, wherein the reminder is associated with the specialist session scheduled by the customer, wherein the reminder is transmitted to the customer a predetermined amount of time prior to the lapse of a wait time associated with the specialist session; and
receiving, by a processing device, a response from the customer acknowledging the reminder within a predetermined amount of time in response to transmitting the reminder, wherein the response is an indication that the customer will reach the business location to participate in the specialist session prior to the lapse of the wait time.

20. The method of claim 19, further comprising:
determining, by a processing device, that the customer has not acknowledged the reminder within the predetermined amount of time;
determining, by a processing device, an alternate wait time associated with the specialist session, wherein the alternate wait time is determined based on at least placing the customer in the next available position in the queue associated with the specialist session; and
transmitting, by a processing device, a notification to the customer, wherein the notification comprises at least the alternate wait time associated with the specialist session to the customer.
